(19) United States
(12) Patent Application Publication
(10) Pub. No.: US 2011/0120391 A1
(43) Pub. Date: May 26, 2011

(54) DRY DOG BAG

(76) Inventor: Marie-Antoinette Novy, Montreal (CA)

(21) Appl. No.: 12/624,723

(22) Filed: Nov. 24, 2009

(51) Int. Cl. A01K 13/00

(52) U.S. Cl. 119/855; 119/865

(57) ABSTRACT

A garment including a back opening section, a bottom section and a front opening section. The head of the animal is passed through the back opening section toward the front opening section. Via the front opening section placket, the mobile neck strap is adjusted on the fix neck strap accordingly to the animal's neck size using a hook and loop fastener. The animal is lead to enter completely into the dry dog or animal garment bag garment having its paws on the bottom section. The garment is covering the back, the sides, the legs and the paws of the animal. The back opening section is closed by wrapping the garment with the mobile belt strap and securing the closing with the hook and loop fastener of the mobile belt strap. The animal is rubbed thoroughly with the absorbent material, and then released when the moist and the debris are removed from the fur.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to garments for animals, such as dogs. More specifically, the present invention relates to a garment that is a bag and adjustable to accommodate animals of different sizes and shapes.

### BACKGROUND OF THE INVENTION

Dogs have long been known as “man's best friend”. The relationship between man and dog has grown even closer in this hectic and fast world. Regardless of the relationship between person and dog and regardless of schedule or weather, the dog should exercise and go outside for it, several times a day. As much as dog owner's and guardians would like to, they cannot change a dog's natural behavior and instincts to; walk in dirt, dig, jump into water puddles, swim, play in snow and slush, play in mud and in addition they must get their occasional bath. Dog's owners and guardians are looking for solutions to facilitate their daily routines.

There does not exist any simple, yet secure and efficient device that serves many purposes including those of drying animals after walks, baths, swimming, etc., while restraining the animal safely and comfortably, for avoiding some skin related rashes and eczemas.

There also does not exist any simple, yet secure and efficient device that helps keep the animal's owner or guardian's living, working, leisure environments, and vehicles, clean, even if their animal is not.

There also does not exist any simple, yet secure and efficient device that helps the environment by diminishing significantly the number of animal washes, product washes, usage of dangerous products and medical creams.

Therefore, what is needed is a device that secure and efficiently device that dries animals after walks, baths, swimming, or other activities while restraining the animal safely and comfortably.

What is also needed is a device to help pet owners and guardians keep their living, working, leisure environments, and vehicles clean, even if their animal is not.

What is also needed is a device that helps the environment and animal by diminishing significantly the number of washes, product washes, usage of dangerous products and medical creams that are necessary.

### SUMMARY OF THE INVENTION

The present invention provides animal owners and guardians an easy to use and safe garment for keeping their environment dry and clean from their wet animal while contributing to the animal's good health, but is not unnecessarily restrictive. The present invention completely encloses the animal in a bag like garment that retains moisture and debris such as sand, mud, dust, gravels, and ice from a wet animal.

For example, after a pet owner has walked their pet and brought their pet to the dog run where the dog played with its friends and rolled in dirt and mud, the pet owner, when entering his home, will have the a dry dog or animal garment bag hanging on the door knob and will easily be able to put it around his pet's neck and the pet will naturally enter the a dry dog or animal garment bag to be handled securely and comfortably. At this time, the pet owner will have control of his pet and will be able to securely handle his pet without worrying of having to clean up dirt and wet paws on his floor and furniture. The present invention helps pet owners and guardians keep their living, working, leisure environments, and vehicles clean, even if their animal is not.

The pet owner or guardian such as a veterinarian, dog walker, pet day care professionals, pets spa professionals, and pet groomers release the animal from the garment once s/he is satisfied of its dryness and cleanliness. In other instances, where an animal may be cold, the thickness and the design of the present invention will contribute in keeping the animal safe and warm and therefore comfortable.

The present invention is ideal for all circumstances when an animal needs to be dried. The present invention can be used for the vehicle, the house, and many other places and any other circumstances the animal's owner or guardian feels it is required.

The dry dog or animal garment bag garment includes a back opening section, a bottom section and a front opening section. The head of the animal is passed through the back opening section toward the front opening section. Thanks to the front opening section placket, the mobile neck strap is adjusted on the fix neck strap accordingly to the animal's neck size using a hook and loop fastener.

The animal is lead to enter completely into the dry dog or animal garment bag garment having its paws on the bottom section. The garment is covering the back, the sides, the legs and the paws of the animal. The back opening section is closed by wrapping the garment with the mobile belt strap and securing the closing with the hook and loop fastener of the mobile belt strap. The animal is rubbed thoroughly with the absorbent material, and then released by the owner or guardian when the moist and the debris are removed from the fur.

It is an objective of the present invention to help the owner or guardian safely dry a wet animal and avoid unpleasant consequences such as, but not limited; bad odor of the animal's fur, skin rash or eczema due to moist fur for long periods of time, and soiled objects such as flooring, furniture or vehicles by water or dirt stains coming from a wet animal.

It is also an objective of the present invention to teach a device that is reusable, washable or disposable in nature which is made from multiple pieces of at least one layer of absorbent material that encloses an animal from it shoulders to its tail, paws, or other extremities.

The present invention allows an effortless usage for great benefits for both animal owner or guardian and animal. Additionally, the present invention may be provided in various sizes to accommodate a large spectrum of dog breeds and other animals such as cats, rabbits, and ferrets.

It is an objective of the present invention to help the animal's owner or guardian to safely dry its animal and avoid unpleasant consequences such as; bad odor of the animal's fur, skin rash or eczema due to moist fur for long periods of time, and water and dirt stains on the floor, furniture or vehicle.

It is a further objective of the present invention to allow the animal's owner or guardian to sustain the water and dirt in a confined environment and be able to easily release the gook by shaking it out wherever the animal owner or guardian wishes to do so.

### BRIEF DESCRIPTION OF THE DRAWINGS

The accompanying drawings, which are incorporated herein an form a part of the specification, illustrate the present invention and, together with the description, further serve to explain the principles of the invention and to enable a person skilled in the pertinent art to make and use the invention.

FIG. 1 is a left side view of a dry dog or animal garment bag of the present invention with adjustable front opening opened showing a mobile and fixed neck straps unattached and with back opening opened showing a mobile belt strap unattached;

FIG. 2 is a right side view of a dry dog or animal garment bag of the present invention with adjustable front opening opened showing a mobile neck strap and with back opening opened and a mobile belt strap unattached;

FIG. 3 is a left side perspective view of a dry dog or animal garment bag of the present invention with adjustable front opening closed showing a mobile neck strap pressed to the fixed neck strap and with back opening closed showing a mobile belt strap attached to itself;

FIG. 4 is a top close up view of the adjustable front opening closed of a dry dog or animal garment bag of the present invention showing a mobile neck strap pressed to the fixed neck strap;

FIG. 5 is a top close up view of the back opening closed of a dry dog or animal garment bag of the present invention showing a mobile belt strap attached to itself;

FIG. 6 is a bottom close up view of the back opening closed of a dry dog or animal garment bag of the present invention showing a mobile belt strap attached to itself; and

FIG. 7 is a left side perspective view of a dry dog or animal garment poncho embodiment of the present invention with adjustable front opening closed showing a mobile neck strap pressed to the fixed neck strap and with back and side sections for covering the back and sides of an animal while allowing the bottom to remain uncovered and open.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

Now referring to the Figures, the present invention provides animal owners or guardians an easy to use and safe garment for keeping their environment dry and clean from their animal while contributing to the animal's good health. The animal garment bag is comprising of an upper section 115 for covering the back of an animal; a lower section 111 for covering the paws of an animal; a first vertical section 112 and second vertical section 113 for covering the sides of an animal; a front vertical section 114 for covering the chest of the animal from the paws to the neck.

The invention helps the owner or guardian to safely dry an animal and avoid unpleasant consequences such as but not limited; bad odor of the animal's fur, skin rash or eczema due to moist fur for long periods of time, and soiled objects such as flooring, and furniture or vehicles by water or dirt stains coming from a wet animal.

The present invention sustains the water and dirt in a confined environment and enables to easily release the gook by shaking it out wherever the animal owner or guardian wishes to do so.

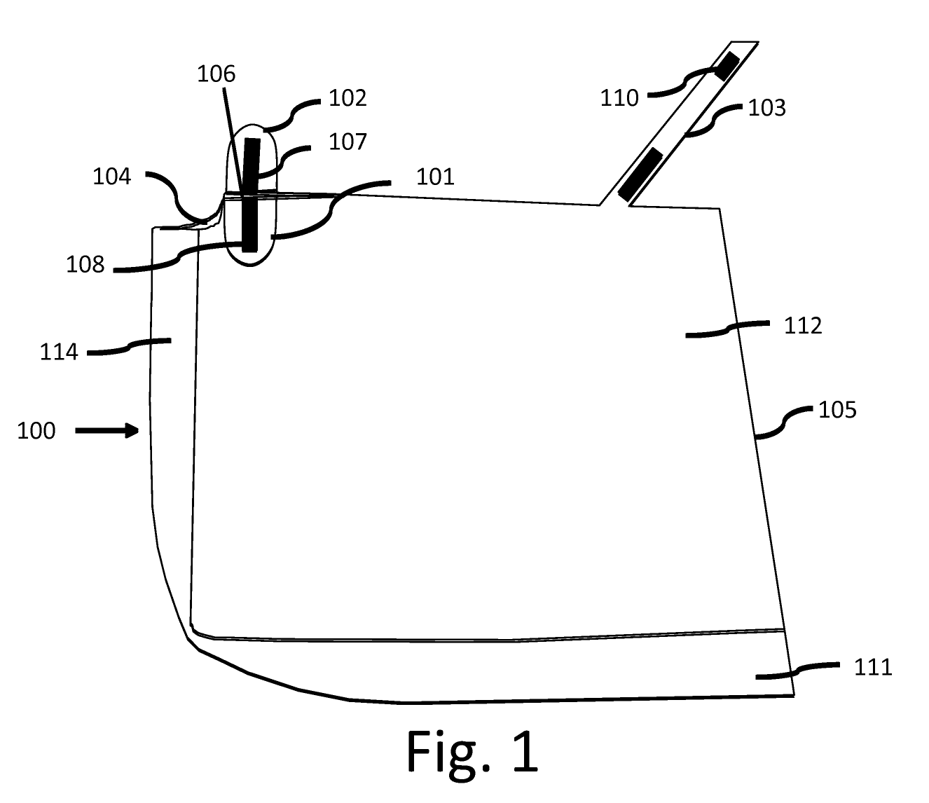

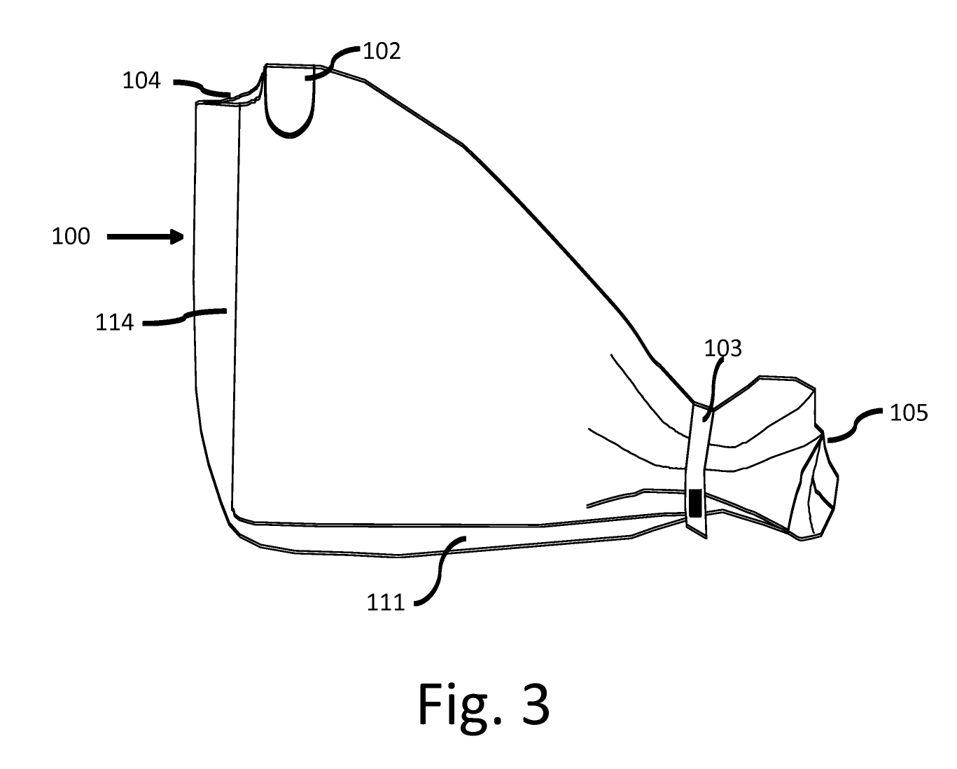

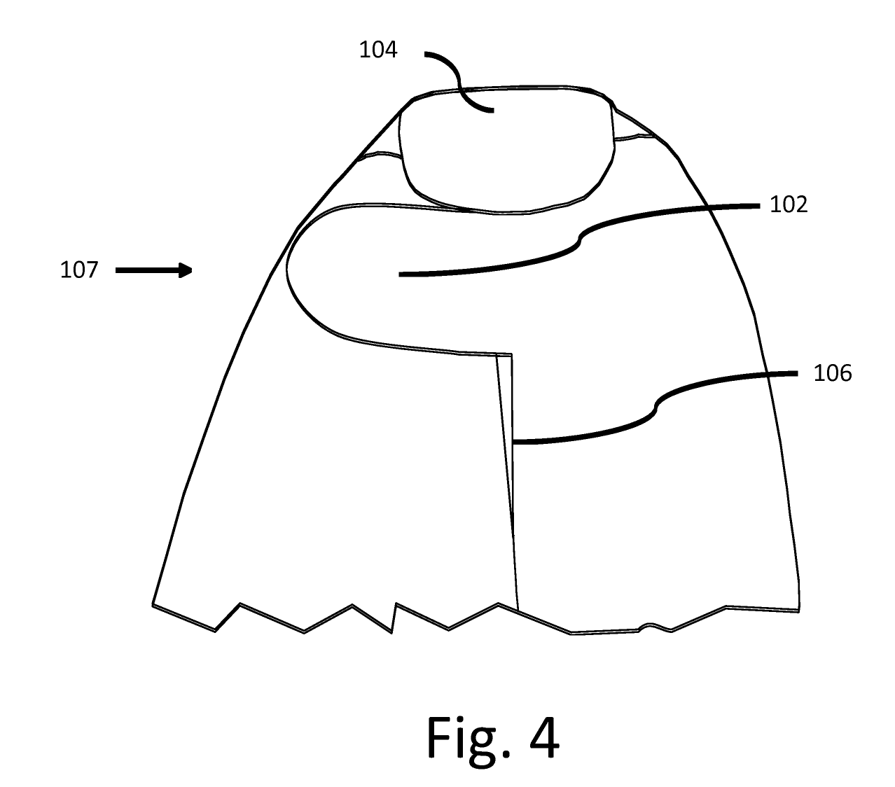

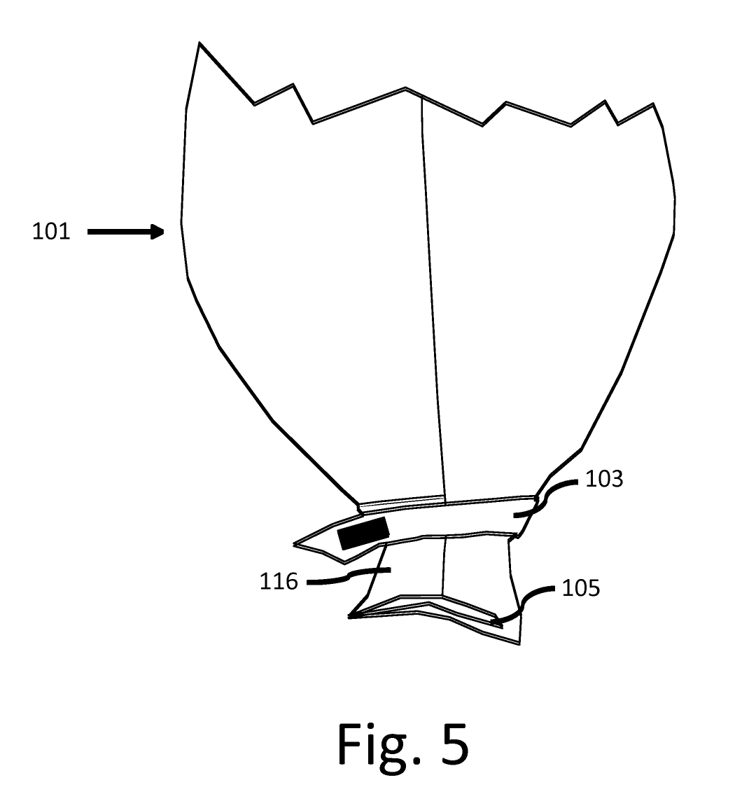

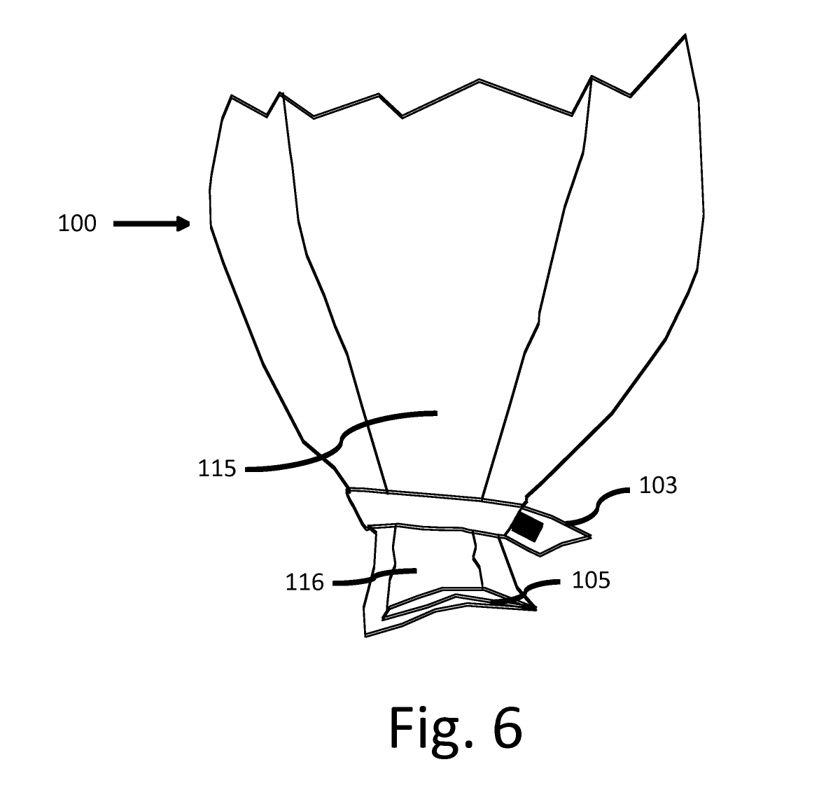

FIG. 1 shows a left side view of a dry dog or animal garment bag 100 with adjustable front opening opened 104 showing a mobile neck strap 102 and a fix neck strap 101 unattached with back opening 105 opened showing a mobile belt strap 103 unattached. A hook and loop fastener 108 is placed on the fix neck strap 101 and another hook and loop fastener 107 is placed on the mobile neck strap 102 in order to secure the closing of the adjustable front opening 104 when the mobile neck strap 102 is placed on the fix neck strap 101, as shown in FIG. 3 and FIG. 4. The mobile belt strap 103 has two hook and loop fasteners 109 and 110 that allows to secure the closing of back the opening 105 when the mobile belt strap 103 is wrapped around the garment, in the manner shown in FIG. 3, FIG. 5 and FIG. 6.

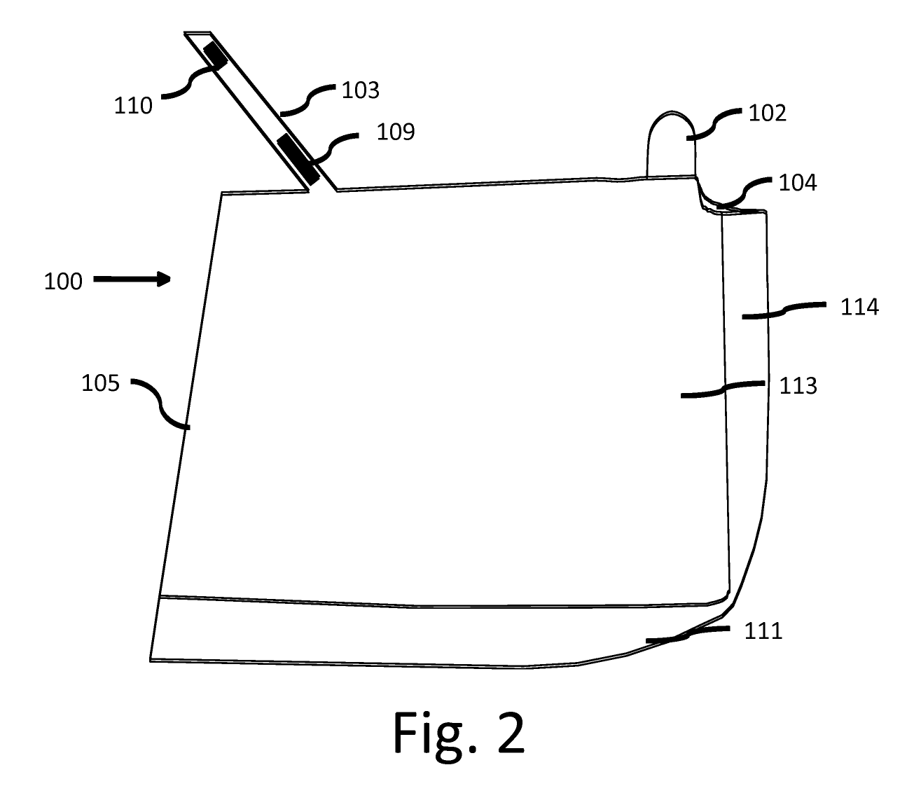

FIG. 2 shows a right side view of a dry dog or animal garment bag 100 with adjustable front opening opened 104 showing a mobile neck strap 102 and with back opening 105 opened and a mobile belt strap 103 unattached. The mobile belt strap 103 has two hook and loop fasteners 109 and 110 that will allow to secure the closing of back the opening 105 when the mobile belt strap 103 is wrapped around the garment from, in the manner in FIG. 3, FIG. 5 and FIG. 6.

FIG. 3 shows a left side view of a dry dog or animal garment bag 100 with adjustable front opening closed showing a mobile neck strap 102 pressed to the fix neck strap 101 and with back opening 105 closed showing a mobile belt strap 103 attached to itself.

FIG. 4 shows a top close up view of the adjustable front opening 104 closed of a dry dog or animal garment bag 100 showing a mobile neck strap 102 pressed to the fix neck strap 101 and the placket 106 enabling the head the animal to easily pass through adjustable front opening 104 when the garment is put on or removed.

FIG. 5 shows a top close up view of a closed back opening 105 of a dry dog or animal garment bag 100 showing a mobile belt strap 103 attached to itself.

FIG. 6 shows a bottom close up view of a closed back opening 105 of a dry dog or animal garment bag 100 showing a mobile belt strap 103 attached to itself.

Dry dog bag 100 is built from a pliable, absorbent, machine-washable, machine-dryable, bulky terry cloth material typically made from synthetic or natural soft fibers, which contributes to the absorbency, the form, the fit and the function. The material can be available in several weights, colors as well as with specific treatments applied such as antimicrobial treatment.

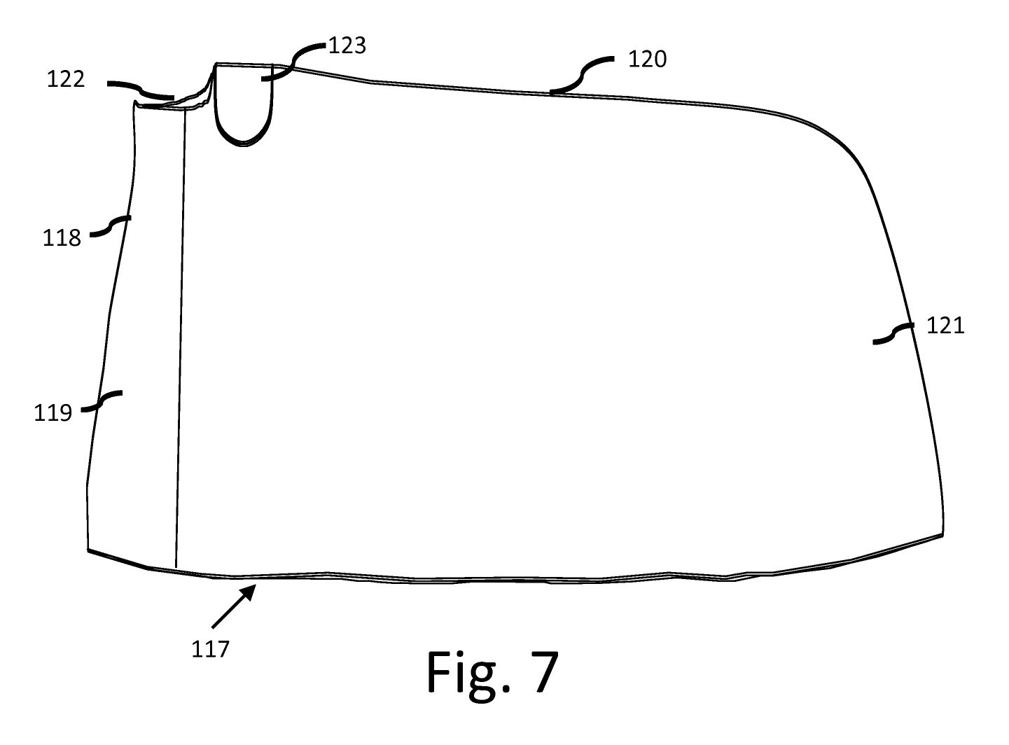

In an alternative embodiment of the present invention shown in FIG. 7, the dry dog bag can be used without the mobile belt strap 103 and by omitting the lower section 111 for covering the paws of an animal. In this embodiment, the present invention is essentially an animal poncho 117 rather than a bag 100. This poncho 117 embodiment is comprised of an adjustable front opening opened 122 showing a mobile neck strap 123; an upper section 118 for covering the back of an animal; a first vertical section 118 and second vertical section 121 for covering the sides of an animal; and a front vertical section 119 for covering the chest of the animal from the paws to the neck. The removal of the lower section 111 for covering the paws makes the inclusion and use of the mobile belt strap 103 moot, as there is now no need to tie the end of the back section 116 closed or to the animal as the upper section 118 covers the entire animals back and the sides are further covered by the vertical sections 118 and 121. This embodiment does not provide the animal with complete coverage, but the trade off is only one fastener is needed to attached the garment to the animals neck as previous taught for the bag embodiment 100 so the garment in its poncho embodiment 117 maybe removed easier and quicker than the bag embodiment 100.

Many of the described features may be substituted, altered or omitted without departing from the spirit and scope of the invention. For example, the particular size and shape can be modified to accommodate different sizes and breeds of dogs, or for different animal species. As yet another example, a water resistant outer layer can be added to the garment to prevent moisture from the environment such as rain, bath, and sea from entering the absorbent material and to prevent moisture from the absorbent material from soiling objects such as carpet, furniture, bedding, and a car seat in the environment.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. An animal garment bag comprising:
an upper section for covering the back of an animal;
a lower section for covering the paws of an animal;
a first vertical section and second vertical section for covering the sides of an animal;
a front vertical section for covering the chest of an animal from the paws to the neck;
the front vertical section includes an opening placket, a mobile neck strap attached on the right side of the opening placket to be adjusted on the fix neck strap accordingly to the animal's neck size using a first fastening means;
the first fastening means provided to fix the neck strap accordingly to the animal's neck size to the front section of the garment bag; and
a back vertical section for the posterior and tail of the animal;
the back section including a large opening to allow the entry of an entire animal's body into the garment bag;
a mobile belt strap attached to the back section of the garment bag; and
a second fastening means provided to close the garment bag by wrapping the garment bag with a mobile belt strap attached to the back section of the garment bag and securing the closing with second fastening means affixed to the mobile belt strap; and
a middle section extending from the front section to the back section.

2. The animal garment bag of claim 1 wherein the fastening means is a hook and loop fastener.

3. The animal garment bag of claim 1 wherein the opening placket facilitates the passage of an animal's head.

4. The animal garment bag of claim 1 wherein the mobile neck strap is attached on the right side of the opening placket to be adjusted on the fix neck strap accordingly to the animal's neck size using hook and loop fasteners.

5. The animal garment bag of claim 1 wherein the back section completely encloses the back, the sides, the tail, the legs and the paws of the animal.

6. The animal garment bag of claim 1 wherein the opening placket is further comprised of:
a mobile neck strap with a hook and loop fastener fixed on the interior side of the mobile neck strap;
a complementary hook and loop fastener fixed to the opposite side of the opening placket; and
the hook and loop fastener and complementary hook and look fastener are provided to secure the mobile neck strap to the fix neck strap over the neck of a animal.

7. The animal garment bag of claim 1 wherein the mobile belt strap attached to the bag garment has hook and loop fasteners at the extremities of its two sides, whereby the mobile belt strap can be secured to itself to close the opening of the a back section when wrapped around the back section of the garment bag.

8. The animal garment bag of claim 1 wherein the mobile belt strap attached to the a dry dog or animal garment bag garment has hook and loop fasteners on both sides of the belt to close the opening of the a back section when wrapped around the back section of the garment bag.

9. The animal garment bag of claim 1 wherein a absorbent water and dirt absorbent fabric is made from one or more layers of a material chosen from the group consisting of micro-fiber towel cloth and natural towel cloth.

10. The animal garment bag of claim 1 wherein a absorbent water and dirt absorbent fabric is made from one or more layers of natural towel cloth.

11. The animal garment bag of claim 1 wherein an absorbent water and dirt absorbent fabric is made from one or more layers of micro-fiber towel cloth.

12. The animal garment bag of claim 1 wherein the lower section may be covered with a detachable outer layer of water repellant fabric.

13. The animal garment bag of claim 1 wherein the animal is lead to enter completely into the garment bag garment by having its paws on the bottom section.

14. An animal garment bag comprising:
an upper section for covering the back of an animal;
a first vertical section and second vertical section for covering the sides of an animal;
a front vertical section for covering the chest of an animal from the paws to the neck;
the front vertical section includes an opening placket, a mobile neck strap attached on the right side of the opening placket to be adjusted on the fix neck strap accordingly to the animal's neck size using a first fastening means;
the first fastening means provided to fix the neck strap accordingly to the animal's neck size to the front section of the garment bag; and
a back vertical section for the posterior and tail of the animal; and
a middle section extending from the front section to the back section.

15. The animal garment bag of claim 1 wherein the fastening means is a hook and loop fastener.

16. The animal garment bag of claim 1 wherein the opening placket facilitates the passage of an animal's head.

17. The animal garment bag of claim 1 wherein the mobile neck strap is attached on the right side of the opening placket to be adjusted on the fix neck strap accordingly to the animal's neck size using hook and loop fasteners.

18. The animal garment bag of claim 1 wherein the back section completely encloses the back, the sides, the tail, and the legs of the animal.

19. The animal garment bag of claim 1 wherein the opening placket is further comprised of:
a mobile neck strap with a hook and loop fastener fixed on the interior side of the mobile neck strap;
a complementary hook and loop fastener fixed to the opposite side of the opening placket; and
the hook and loop fastener and complementary hook and look fastener are provided to secure the mobile neck strap to the fix neck strap over the neck of a animal.

20. The animal garment bag of claim 1 wherein an absorbent water and dirt absorbent fabric is made from one or more layers of a material chosen from the group consisting of micro-fiber towel cloth and natural towel cloth.

21. The animal garment bag of claim 1 wherein a absorbent water and dirt absorbent fabric is made from one or more layers of natural towel cloth.

22. The animal garment bag of claim 1 wherein a absorbent water and dirt absorbent fabric is made from one or more layers of micro-fiber towel cloth.

23. The animal garment bag of claim 1 wherein the lower side may be covered with a detachable outer layer of water repellant fabric.
